(19) United States
(12) Patent Application Publication
(10) Pub. No.: US 2018/0093379 A1
(43) Pub. Date: Apr. 5, 2018

(54) ROBOT CONTROL APPARATUS, ROBOT, AND ROBOT SYSTEM

(71) Applicant: Seiko Epson Corporation, Tokyo (JP)

(72) Inventor: Yasuhiro SHIMODAIRA, Matsumoto (JP)

(21) Appl. No.: 15/714,074

(22) Filed: Sep. 25, 2017

(30) Foreign Application Priority Data
Sep. 30, 2016 (JP) 2016-194386

(51) Int. Cl. B25J 9/16; B25J 15/02

(52) U.S. Cl. CPC B25J 9/1679; B25J 15/0206; B25J 9/1694

(57) ABSTRACT

A robot control apparatus includes a processor that is configured to execute computer-executable instruction so as to control a robot including a force detection section, wherein the processor is configured to reset the force detection section before a first target object is inserted into a second target object and after the first target object has been inserted into the second target object.

### BACKGROUND

### 1. Technical Field

The present invention relates to a robot control apparatus, a robot, and a robot system.

### 2. Related Art

Research and development of a robot that performs a task including the action of inserting one of two objects into an insertion section of the other object are underway.

As an example of the robot described above, JP-A-2015-85497 discloses a robot that performs the task of inserting a key into a keyhole of a lock and causing the key to pivot to lock or unlock the lock.

JP-A-2015-85497, however, does not describe how to control to cause the robot to insert the key into the keyhole of the lock and rotate the key. That is, in JP-A-2015-85497, how to control the robot when the lock is locked or unlocked is unavailable.

Further, it is difficult in related art for a robot to perform the task of inserting a key into the keyhole of a lock and cause the key to pivot to lock or unlock the lock.

### SUMMARY

An advantage of some aspects of the invention is to solve at least a part of the problems described above, and the invention can be implemented as the following forms or application examples.

A robot control apparatus according to an aspect of the invention is a robot control apparatus includes a processor is configured to execute computer-executable instruction so as to control a robot including a force detection section, wherein the processor is configured to reset the force detection section before a first target object is inserted into a second target object and after the first target object has been inserted into the second target object.

With this configuration, for example, the action of inserting the first target object into the second target object and causing the first target object to pivot relative to the second target object in a predetermined direction can be properly performed.

In the robot control apparatus according to the aspect of the invention, it is preferable that points of time after the first target object is inserted into the second target object are points of time after the insertion but before the first target object is pulled out of the second target object.

With this configuration, for example, the action of inserting the first target object into the second target object, causing the first target object to pivot relative to the second target object in a predetermined direction, and pulling the first target object out of the second target object can be properly performed.

In the robot control apparatus according to the aspect of the invention, it is preferable that points of time after the first target object is inserted into the second target object are points of time after the first target object is pulled out of the second target object but before the first target object is inserted into the second target object again.

With this configuration, for example, the action of inserting the first target object into the second target object, causing the first target object to pivot relative to the second target object in a predetermined direction, pulling the first target object out of the second target object, inserting the first target object into the second target object again, causing the first target object to pivot relative to the second target object in a predetermined direction, and pulling the first target object out of the second target object can be properly performed.

In the robot control apparatus according to the aspect of the invention, it is preferable that the processor is configured to, after performing the insertion, control an action of the robot in such a way that the first target object is caused to pivot relative to the second target object in a first direction while performing a pressing action of pressing the first target object against the second target object in a direction in which the first target object is inserted into the second target object, and perform force control with target force set in a direction of the insertion based on an output from the force detection section in the pressing action.

The action of causing the first target object to pivot relative to the second target object in the first direction can therefore be properly performed.

In the robot control apparatus according to the aspect of the invention, it is preferable that the processor is configured to perform position control to cause the first target object to pivot relative to the second target object in the first direction.

The action of causing the first target object to pivot relative to the second target object in the first direction can therefore be properly performed.

In the robot control apparatus according to the aspect of the invention, it is preferable that the processor is configured to perform compensation relating to gravity.

With this configuration, for example, the action of inserting the first target object into the second target object and causing the first target object to pivot relative to the second target object in a predetermined direction can be properly performed.

In the robot control apparatus according to the aspect of the invention, it is preferable that the first target object is a key and the second target object is a lock.

With this configuration, the action of inserting the key into the keyhole of the lock and causing the key to pivot in a predetermined direction to lock and unlock the lock can be properly performed.

A robot according to another aspect of the invention is a robot that includes a force detection section and inserts a first target object into a second target object, and the robot is controlled by the robot control apparatus according to the aspect of the invention.

With this configuration, for example, the action of inserting the first target object into the second target object and causing the first target object to pivot relative to the second target object in a predetermined direction can be properly performed.

A robot system according to another aspect of the invention is a robot system including the robot control apparatus according to the aspect of the invention and the robot controlled by the robot control apparatus.

With this configuration, for example, the action of inserting the first target object into the second target object and causing the first target object to pivot relative to the second target object in a predetermined direction can be properly performed.

### BRIEF DESCRIPTION OF THE DRAWINGS

The invention will be described with reference to the accompanying drawings, wherein like numbers reference like elements.

FIG. 1 is a perspective view showing a robot system according to an embodiment of the invention.

FIG. 2 is a side view showing an example in which a key grasped by an end effector is viewed along an X axis in a robot coordinate system from the positive side of the X axis toward the negative side thereof.

FIG. 3 shows an example of the hardware configuration of a robot control apparatus.

FIG. 4 shows an example of the functional configuration of the robot control apparatus.

FIG. 5 describes the action of a robot in a locking task.

FIG. 6 describes the action of the robot in the locking task.

FIG. 7 describes the action of the robot in the locking task.

FIG. 8 describes the action of the robot in the locking task.

FIG. 9 describes the action of the robot in the locking task.

FIG. 10 describes the action of the robot in the locking task.

FIG. 11 is a flowchart showing control actions of the robot control apparatus in the locking task.

### DESCRIPTION OF EXEMPLARY EMBODIMENTS

A robot control apparatus, a robot, and a robot system according to an embodiment of the invention will be described below in detail with reference to the accompanying drawings.

### Configuration of Robot System

The configuration of a robot system 1 will first be described.

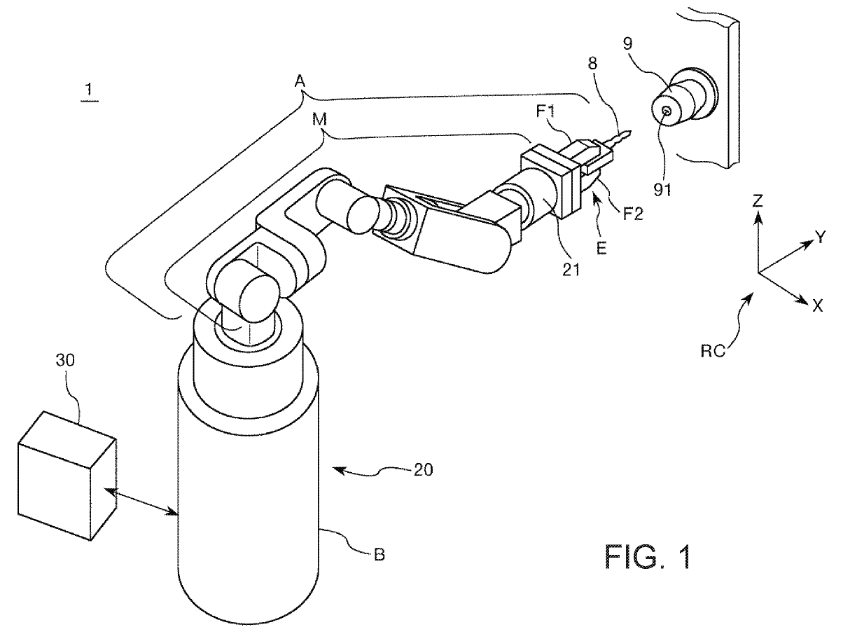

FIG. 1 is a perspective view showing a robot system according to an embodiment of the invention.

In the following description, the direction of an X axis of a coordinate system and the direction parallel to the X axis are also called an “X direction,” and the positive and negative X directions are also called a “positive side of X direction” and a “negative side of X direction,” respectively. Similarly, the direction of a Y axis of the coordinate system and the direction parallel to the Y axis are also called a “Y direction,” and the positive and negative Y directions are also called a “positive side of Y direction” and a “negative side of Y direction,” respectively. Similarly, the direction of a Z axis of the coordinate system and the direction parallel to the Z axis are also called a “Z direction, ” and the positive and negative Z directions are also called a “positive side of Z direction” and a “negative side of Z direction,” respectively.

The internal configuration of a lock, which is inherently complicated, is simplified and diagrammatically shown in the drawings of the embodiment.

The robot system 1 includes a robot 20 and a robot control apparatus 30, which controls the robot 20, as shown in FIG. 1. The robot 20 includes a force detection section 21 and is controlled by the robot control apparatus 30.

The robot 20 includes an arm A (manipulator M) , which is provided with the force detection section 21 and which is an example of a movable section provided with the force detection section, and a support bench B (base), which supports the arm A.

The force detection section 21 may or may not be one of the components of the arm A, and it is assumed in the following description that the force detection section 21 is one of the components of the arm A. It is noted that the arm A only needs to be provided with at least part of the force detection section 21. That is, the arm A may be provided with part of the force detection section 21 or the entire force detection section 21, and it is assumed in the following description that the arm A is provided with the entire force detection section 21.

The robot 20 is a single-arm robot, in detail, a vertical multi-joint (seven-axis) single-arm robot. A single-arm robot is a robot including one arm, such as the arm A. The robot 20 may be a multi-arm robot in place of a single-arm robot. A multi-arm robot is a robot including at least two arms (at least two arms A, for example). Among multi-arm robots, a robot including two arms is also referred to as a double-arm robot. That is, the robot 20 may be a double-arm robot including two arms or a multi-arm robot including at least three arms (at least three arms A, for example). Still instead, the robot 20 may be a horizontal multi-joint robot, such as a SCARA robot, a cartesian coordinate robot, a multi-ped walking (traveling) robot including legs, or any other robot. The cartesian coordinate robot is, for example, a gantry robot.

The arm A includes an end effector E, the manipulator M, and the force detection section 21.

The end effector E is an end effector including a finger section capable of grasping an object, that is, a hand. The finger section includes at least two fingers. The following description will be made with reference to, as an example, a case where the finger section includes two fingers, a finger F1 and a finger F2. The end effector E causes the fingers F1 and F2 to sandwich an object to grasp the object. The end effector E is not limited to the end effector including the finger section and may instead be an end effector having a configuration in which an object is sucked and grasped (suck and grasp) or any other end effector capable of grasping an object with the aid of a magnet, a jig, or any other component.

The finger section with which the end effector E is provided is connected to the robot control apparatus 30 via a cable in a communicable manner. The finger section therefore allows each of the fingers F1 and F2 to act on the basis of a control signal acquired from the robot control apparatus 30. The wired communication via the cable is communication compliant with Ethernet (registered trademark), USB (universal serial bus), or any other standard. The finger section may instead be connected to the robot control apparatus 30 over wireless communication based on Wi-Fi (registered trademark) or any other communication standard.

The manipulator M includes seven links and seven joints. The seven joints each include an actuator that is not shown. That is, the arm A including the manipulator M is a seven-axis vertical multi-joint arm. Specifically, the support bench B and one of the links are linked to each other via a joint, and the joint has a mechanism that supports the links linked to each other in such a way that the links can pivot relative to the support bench B. Two links adjacent to each other are similarly linked to each other via a joint, and the joint has a mechanism that supports the links linked to each other in such a way that one of the links can pivot relative to the other. The thus configured arm A performs a coordinated action performed by the support bench B, the end effector E, the manipulator M, and the actuators in the seven joints provided in the manipulator M to achieve actions having seven degrees of freedom around the seven axes. The arm A may instead be configured to perform actions having six degrees of freedom or smaller or actions having eight degrees of freedom or greater.

In the case where the arm A performs actions having seven degrees of freedom, the number of possible postures of the arm A is greater than that in the case where the arm A performs actions having six degrees of freedom or smaller. The arm A can therefore, for example, perform a smooth action readily and readily avoid interference with an object present around the arm A. Further, in the case where the arm A performs actions having seven degrees of freedom around the seven axes, the arm A can be controlled more readily than in the case where the arm A performs actions having eight degrees of freedom or grater because the amount of calculation is smaller.

The actuators provided in the seven joints provided in the manipulator M are each connected to the robot control apparatus 30 via a cable in a communicable manner. The actuators therefore each cause the manipulator M to act on the basis of a control signal acquired from the robot control apparatus 30. The wired communication via the cable is communication compliant with Ethernet (registered trademark), USB, or any other standard. Part or entirety of the seven actuators provided in the manipulator M may instead be connected to the robot control apparatus 30 over wireless communication based on Wi-Fi (registered trademark) or any other communication standard.

The force detection section 21 is provided in a position between the end effector E and the manipulator M. An example of the force detection section 21 maybe a force sensor. The force sensor is not limited to a specific one and can be any of a variety of force sensors. An example of the force sensor may, for example, be a six-axis force sensor that detects force components in the axial directions of the three axes perpendicular to one another and moment components around the three axes. The force detection section 21 detects force and moment (torque) acting on the end effector E or an object grasped by the end effector E. The force detection section 21 outputs, as an output value therefrom, force detection information containing the value representing the magnitude of the detected force or moment to the robot control apparatus 30 over the communication.

The force detection information is used to perform control based on the force detection information among a variety of types of control performed by the robot control apparatus 30 on the arm A. The control based on the force detection information is, for example, force control, such as impedance control (compliant motion control).

The force detection section 21 is connected to the robot control apparatus 30 via a cable in a communicable manner. The wired communication via the cable is communication compliant with Ethernet (registered trademark), USB, or any other standard. The force detection section 21 and the robot control apparatus 30 may instead be connected to each other over wireless communication based on Wi-Fi (registered trademark) or any other communication standard.

The robot 20 may include at least one imaging section in addition to the functional portions described above. The following description will be made with reference to, as an example, a case where the robot 20 includes no imaging section.

The robot control apparatus 30 is, for example, a robot controller. The robot control apparatus 30 generates a control signal on the basis of an action program inputted in advance. The robot control apparatus 30 transmits the generated control signal to the robot 20 to cause the robot to perform a predetermined task. In the following description, the control signal generation and transmission performed by the robot control apparatus 30 will not be described for ease of description, and the following description will be made of actions that the robot control apparatus 30 causes the robot 20 to perform and processes carried out by the robot control apparatus 30 when the robot control apparatus 30 causes the robot 20 to act. Part or entirety of the robot control apparatus 30 may instead be built in the robot 20 in place of the configuration in which the robot control apparatus 30 is a component separate from the robot 20 and provided in a position external to the robot 20, as shown in FIG. 1.

### Overview of Task Performed by Robot

An example of an overview of the task performed by the robot 20 in the present embodiment will be described below.

The robot 20 performs the action of inserting a first target object into a second target object. In more detail, the robot 20 performs a task including the action of sandwiching the first target object along two directions, the direction of gravity and the direction opposite the direction of gravity, to grasp the first target object and inserting the first target object into an insertion section provided in the second target object (insertion task) . The robot 20 may instead sandwich the first target object along directions different from the directions described above to grasp the first target object.

The present embodiment will be made with reference to, as an example, a case where the negative Z-axis direction in a robot coordinate system RC coincides with the direction of gravity. The robot coordinate system RC is a three-dimensional local coordinate system with reference to which the robot control apparatus 30 causes the arm A to move. The negative Z-axis direction in the robot coordinate system RC may instead coincide with a direction different from the direction of gravity.

Further, the present embodiment will be described with reference to, as an example, a case where the first target is a key 8 and the second target is a lock 9. The lock 9 has a keyhole 91 as an example of the insertion section that allows the key 8 to be inserted, and in the task performed by the robot 20, the robot 20 inserts the key 8 into the keyhole 91 and causes the key 8 to pivot in a predetermined direction to lock and unlock the lock 9. Moreover, the present embodiment will be described, on the assumption that the direction in which the key 8 is caused to pivot is, as an example, defined as follows: the first direction is the direction in which the lock 9 is locked; and the second direction, which is opposite the first direction, is the direction in which the lock 9 is unlocked. The direction in which the key 8 is caused to pivot may instead be conversely defined as follows: the first direction is the direction in which the lock 9 is unlocked; and the second direction is the direction in which the lock 9 is locked.

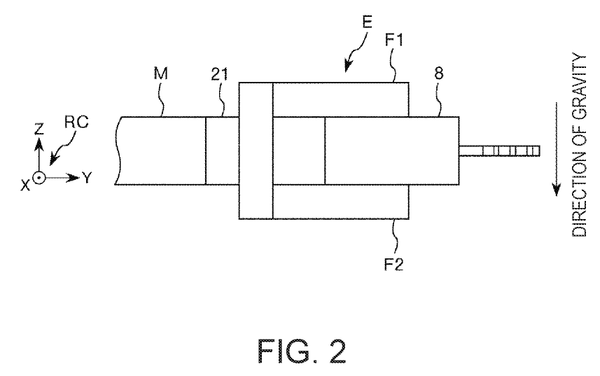

A method for allowing the end effector E of the robot 20 to grasp the key 8 will be described with reference to FIG. 2.

FIG. 2 is a side view showing an example in which the key grasped by the end effector is viewed along the X axis in the robot coordinate system from the positive side of the X axis toward the negative side thereof. In the side view, out of the joints provided in the manipulator M, the pivotal axis of the joint that allows the end effector E to pivot coincides with the Y axis in the robot coordinate system RC.

The end effector E causes the fingers F1 and F2 to act in such a way that they sandwich the key 8 along two directions, the direction of gravity and the direction opposite the direction of gravity, to grasp the key 8 as shown in FIG. 2. The direction of gravity coincides with the negative Z-axis direction in the robot coordinate system RC, as described above. That is, the end effector E causes the finger F1 to move in the direction of gravity to approach the key 8, causes the finger F2 to move in the opposite direction to approach the key 8 so that the fingers F1 and F2 sandwich the key 8 to grasp the key 8. Therefore, in the example shown in FIG. 2, the finger F1 is in contact with a side of the key 8, the side thereof facing the positive side of the Z axis, and the finger F2 is in contact with a side of the key 8, the side thereof facing the negative side of the Z axis.

The robot 20 can thus makes use of the weight of the key 8 to suppress shift of the relative positional relationship in the direction of gravity between the end effector E, which is the portion that forms the robot 20 and sandwiches the key 8, and the key 8. In the case where there is no shift of the positional relationship in the direction of gravity, the robot 20 can omit, out of actions of searching for the keyhole 91 when the end effector E inserts the key 8 into the keyhole 91, the action in the direction along the direction of gravity. As a result, the robot 20 can reduce the period required to insert the key 8 into the keyhole 91 of the lock 9.

The method for allowing the end effector E to grasp the key 8 is not limited to the method described above. For example, in a case where the structures of the key 8 and the lock 9 differ from those in the present embodiment, the end effector E may cause the fingers F1 and F2 to grasp the key 8 with the position of the key 8 restricted in a direction perpendicular to the direction of gravity. In this case, the robot 20 can suppress shift of the relative positional relationship in the direction perpendicular to the direction of gravity between the end effector E, which is the portion that forms the robot 20 and sandwiches the key 8, and the key 8, whereby the robot 20 can further reduce the period required to insert the key 8 into the keyhole 91 of the lock 9.

In the example shown in FIG. 1, the robot 20 causes the fingers F1 and F2 to grasp the key 8 in advance with the key 8 sandwiched in the direction of gravity and fixed, as shown in FIG. 2. The robot 20 may instead not grasp the key 8 in advance but grasp the key 8 disposed in a predetermined area. Still instead, the robot 20 maybe configured to perform another task.

### Description of Point of Interest

The following description will be made of, as an example, a case in which the lock 9 is so disposed that the positive side of the Y axis of the robot coordinate system RC coincides with the positive side of the direction in which the key 8 is inserted into the keyhole 91. That is, the direction opposite the direction in which the key 8 having been inserted into the keyhole 91 is pulled out of the keyhole 91 coincides with the positive Y-axis direction. The lock 9 may instead be so disposed that the positive side of the direction in which the key 9 is inserted into the keyhole 91 coincides with a side of another direction different from the positive Y-axis direction.

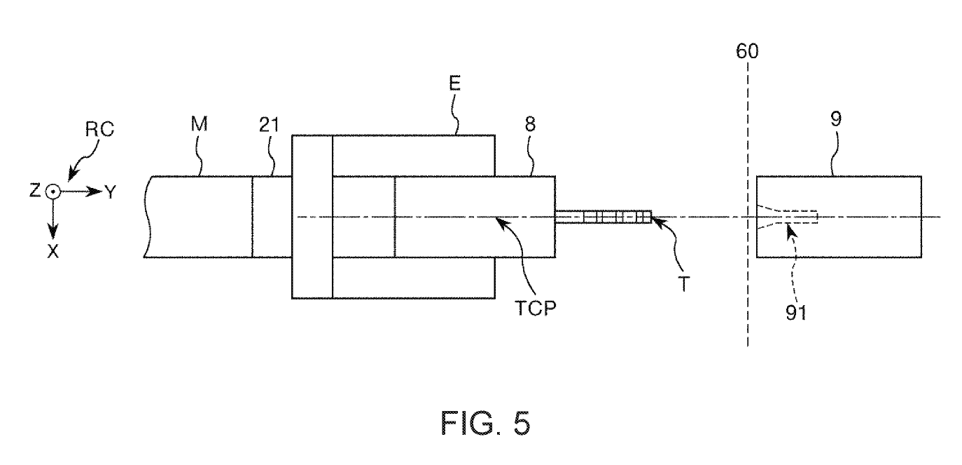

On a front end portion (front end) of the key 8 is set a point of interest T (see FIG. 5), which moves along with the front end portion. The front end portion of the key 8 is, out of two end portions of the key 8, an end portion to be inserted into the keyhole 91.

At the point of interest T is set a point-of-interest coordinate system that is a three-dimensional local coordinate system representing the position and posture of the key 8. The origin of the point-of-interest coordinate system represents the position of the point of interest T, that is, the front end portion of the key 8. Further, the directions of the coordinate axes of the point-of-interest coordinate system represent the posture of the point of interest T, that is the front end portion of the key 8. For example, the point-of-interest coordinate system is so set at the point of interest T that the positive Z-axis direction in the point-of-interest coordinate system coincides with the positive Y-axis direction of the robot coordinate system RC and the positive X-axis direction of the point-of-interest coordinate system coincides with the positive X-axis direction of the robot coordinate system RC in a state in which the key 8 is inserted in the keyhole 91.

### Hardware Configuration of Robot Control Apparatus

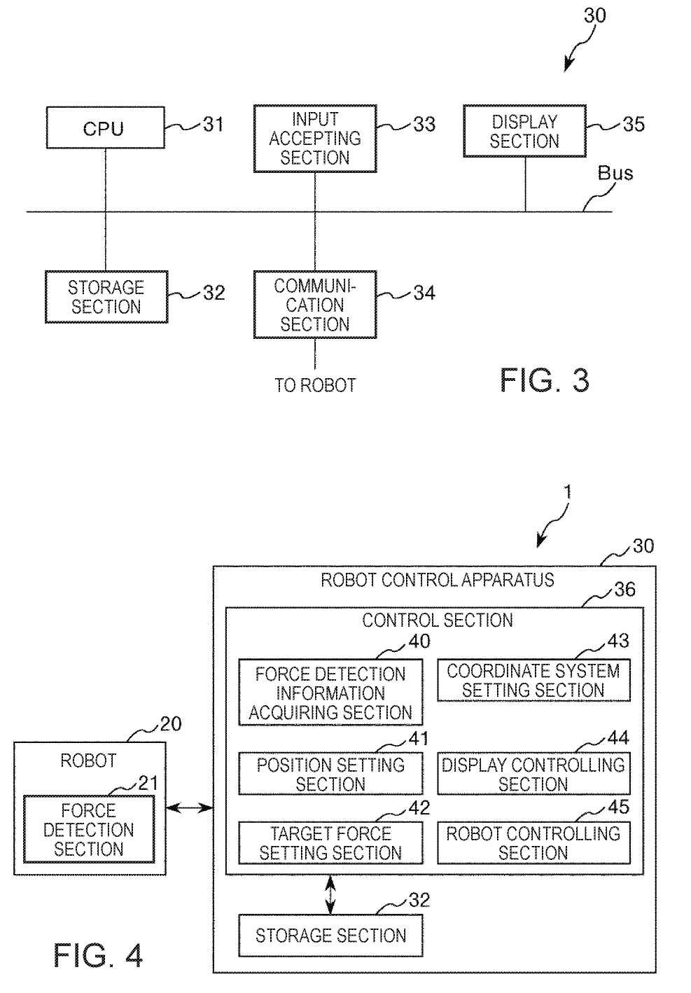

The hardware configuration of the robot control apparatus 30 will be described below with reference to FIG. 3. FIG. 3 shows an example of the hardware configuration of the robot control apparatus. The robot control apparatus 30 includes, for example, a CPU (central processing unit) 31, a storage section 32, which stores a variety of pieces of information, an input accepting section 33, a communication section 34, and a display section 35, which displays a variety of pieces of information. These components are so connected to a bus Bus as to be capable of communicating with one another via the bus Bus. The robot control apparatus 30 communicates with the robot 20 via the communication section 34.

The CPU 31 executes a variety of programs stored in the storage section 32.

The storage section 32 includes, for example, an HDD (hard disk drive), an SSD (solid state drive), an EEPROM (electrically erasable programmable read-only memory), a ROM (read-only memory), or a RAM (random access memory). The storage section 32 is not necessarily built in the robot control apparatus 30 and may instead be an external storage device connected via an USB port or any other digital input/output port. The storage section 32 stores, for example, a variety of pieces of information and programs processed by the robot control apparatus 30.

The input accepting section 33 is an input device, for example, a teaching pendant including a keyboard and a mouse, a touch pad, or any other component. The input accepting section 33 may be integrated with the display section 35 to form, for example, a touch panel.

The communication section 34 is formed, for example, of a digital input/output port, such as an USB port, or an Ethernet (registered trademark) port.

The display section 35 is, for example, of a liquid crystal display panel or an organic EL (ElectroLuminescence) display panel.

### Functional Configuration of Robot Control Apparatus

The functional configuration of the robot control apparatus 30 will next be described below with reference to FIG. 4. FIG. 4 shows an example of the functional configuration of the robot control apparatus. The robot control apparatus 30 includes the storage section 32 and a control section 36.

The control section 36 controls the action of each portion of the robot control apparatus 30 (robot 20). The control section 36 includes a force detection information acquiring section 40, a position setting section 41, a target force setting section 42, a coordinate system setting section 43, a display controlling section 44, and a robot controlling section 45. The functional portions provided in the control section 36 is achieved, for example, when the CPU 31 executes the variety of programs stored in the storage section 32. Part or entirety of the functional portions may be hardware functional portions of an LSI (large scale integration), an ASIC (application specific integrated circuit), or any other circuit.

The force detection information acquiring section 40 acquires, for example, the force detection information from the force detection section 21.

The position setting section 41 sets, for example, a first position and a second position that will be described later. The position setting section 41 allows a variety of insertion tasks to be handled, whereby the insertion tasks can be quickly performed.

The target force setting section 42 sets, for example, first target force and second target force that will be described later. The target force setting section 42 allows a variety of insertion tasks to be handled, whereby the insertion tasks can be quickly performed.

The coordinate system setting section 43 sets, for example, a local coordinate system LC, which is an example of a coordinate system having an axis along the direction in which the first target object is inserted. The coordinate system setting section 43 allows reduction in the period required for teaching performed by an operator and the period required for confirmation of a result of the teaching.

The display controlling section 44 causes the display section 35 to display, for example, a variety of pieces of information. The display controlling section 44 allows visual confirmation of the variety of pieces of information.

The robot controlling section 45 performs, for example, force control on the arm A, for example, on the basis of the force detection information acquired by the force detection information acquiring section 40. That is, the robot controlling section 45 performs the force control, for example, on the basis of the force detection information acquired by the force detection information acquiring section 40, performs the force control and position control, for example, on the basis of the force detection information, or performs the position control to cause the robot 20 to act.

The robot controlling section 45 further controls the arm A on the basis of an insertion position where the key 8 has been successfully inserted into the keyhole 91 and the number of successful insertion actions. The robot controlling section 45 allows a quick insertion task, for example, by attempting to perform an insertion task using, as a target position, an insertion position where many successful insertion actions have occurred.

How robot control apparatus causes robot to perform task

The robot system 1 performs the task including the action of causing the robot control apparatus 30 to control the robot 20 in such a way that the arm A of the robot 20 moves the key 8, which is an example of the first target object, to insert the key 8 into the keyhole 91 of the lock 9, which is an example of the second target object.

Specifically, a locking task is performed as follows: the arm A of the robot 20 grasps and moves the key 8; inserts the key 8 into the keyhole 91 of the lock 9 that has not been locked; causes the key 8 to pivot relative to the lock 9 in the first direction to lock the lock 9; and pulls the key 8 out of the keyhole 91, and an unlocking task is performed as follows: the arm A of the robot 20 grasps and moves the key 8; inserts the key 8 into the keyhole 91 of the lock 9 that has been locked; causes the key 8 to pivot relative to the lock 9 in the second direction to unlock the lock 9; and pulls the key 8 out of the keyhole 91. In this case, the arm A may grasp and move the key 8, insert the key 8 into the keyhole 91 of the lock 9 that has not been locked, cause the key 8 to pivot relative to the lock 9 in the first direction to lock the lock 9, temporarily releases the key 8 to achieve a state in which the key 8 is inserted into the keyhole 91, grasps the key 8 again, cause the key 8 to pivot relative to the lock 9 in the second direction to unlock the lock 9, and pull the key 8 out of the keyhole 91. The second direction is the direction opposite the first direction. The present embodiment will be described with reference to a case where the lock 9 is provided in a door (such as door knob).

In the locking task, the arm A performs the action of moving the key 8 to an insertion action start position 60 close to the keyhole 91 of the lock 9, the insertion action of inserting the key 8 located in the insertion action start position 60 into the keyhole 91, the pivotal action of causing the key 8 to pivot relative to the lock 9 in the first direction, and the pull-out action of pulling the key 8 out of the keyhole 91. The first direction is the clockwise or counterclockwise direction of the pivotal motion around an axis parallel to the direction in which the key 8 is inserted into the keyhole 91 (hereinafter also referred to as “insertion direction”). In general, the first direction is the counterclockwise direction but may instead be the clockwise direction.

Further, in the unlocking task, the arm A performs the action of moving the key 8 to the insertion action start position 60 close to the keyhole 91 of the lock 9, the insertion action of inserting the key 8 located in the insertion action start position 60 into the keyhole 91, the pivotal action of causing the key 8 to pivot relative to the lock 9 in the second direction, and the pull-out action of pulling the key 8 out of the keyhole 91.

Since the locking task and the unlocking task are the same task except that the key 8 is caused to pivot in different directions, and the locking task will therefore be representatively described.

The control performed by the robot control apparatus 30 and the actions of the robot 20 in the locking task will next be described.

No description will be made of how to teach the robot 20, and it is assumed that the teaching has been already completed and the local coordinate system LC (user coordinate system) has been set in the teaching. The local coordinate system LC is an example of the coordinates system having an axis along the direction in which the key 8 is inserted. In the present embodiment, the local coordinate system LC is a three-dimensional local coordinate system which has a Z axis extending along the direction in which the key 8 is inserted and in which the positive side of the insertion direction is the positive side of the Z axis (positive side of Z direction).

In the present embodiment, the origin of the local coordinate system LC is a tool center point TCP of the robot 20 (see FIG. 5) in the case where the point of interest T on the key 8 is located in the insertion action start position 60 close to the keyhole 91 of the lock 9 in the teaching, that is, the position of the center of the front end of the end effector E. The origin is therefore set in the fixed position. That is, any action of the robot 20 does not displace the local coordinate system LC. The local coordinate system LC is so set that the positive Z-axis direction in the local coordinate system LC coincides with the positive Y-axis direction in the robot coordinate system RC, the positive X-axis direction in the local coordinate system LC coincides with the positive Z-axis direction in the robot coordinate system RC, and the positive Y-axis direction in the local coordinate system LC coincides with the positive X-axis direction in the robot coordinate system RC. In the following description, the local coordinate system LC is used.

Characteristics of the robot system 1 will first be briefly described.

The control section 36 of the robot control apparatus 30 resets the force detection section 21 before the key 8 (first target object) is inserted into the keyhole 91 of the lock 9 (second target object) and after the key 8 is inserted into the keyhole 91 of the lock 9. The locking and unlocking tasks can therefore be properly performed.

Points of time after the key 8 is inserted into the keyhole 91 of the lock 9 are, as an example, points of time after the insertion but before the key 8 is pulled out of the lock 9. The locking and unlocking tasks can therefore be properly performed. A detailed description will be made below.

The points of time after the key 8 is inserted into the keyhole 91 of the lock 9 are, as another example, points of time after the key 8 is pulled out of the lock 9 but before the key 8 is inserted again into the keyhole 91 of the lock 9. The locking and unlocking tasks can therefore be properly performed. A detailed description will be made below.

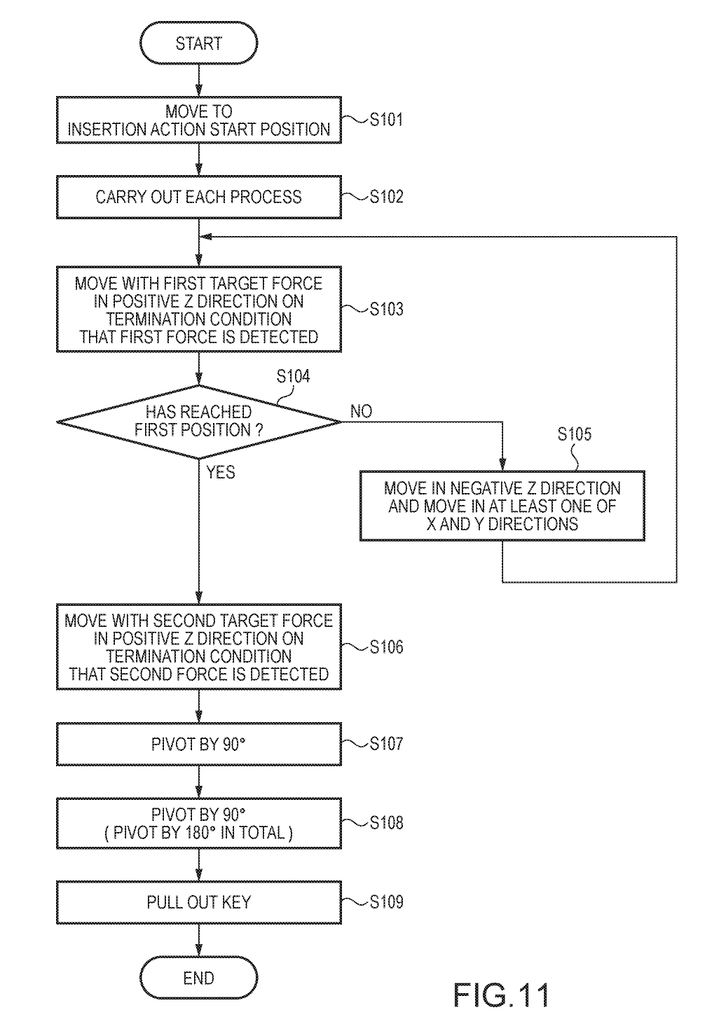

FIGS. 5 to 10 describe the actions of the robot in the locking task. FIG. 11 is a flowchart showing control actions of the robot control apparatus in the locking task.

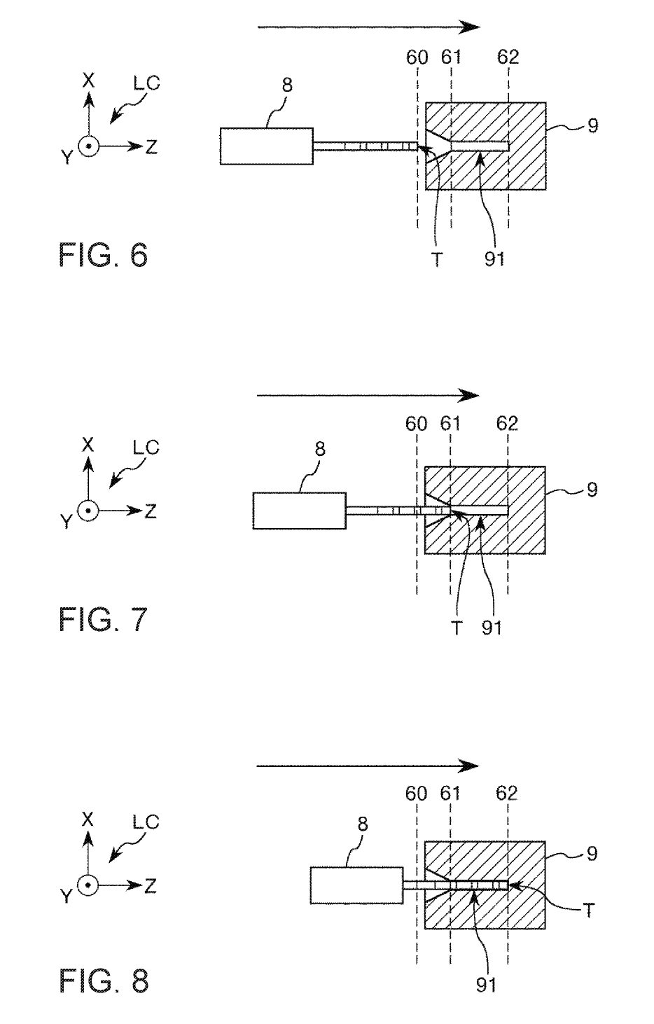

In FIGS. 6 to 10, the robot 20 is not illustrated. Further, in FIGS. 6 to 10, the local coordinate system LC is so drawn that the position of the origin thereof is shifted toward the negative side of the Z direction in the local coordinate system LC. In FIG. 11, no description is made of the action in which the robot 20 extracts the key 8 from a section where the key 8 is accommodated or the action in which after the lock 9 is locked, the key 8 is returned to the accommodation section.

In the locking task, the robot control apparatus 30 controls and drives the robot 20. The robot 20 causes the arm A to grasp the key 8, extract the key 8 from the section where the key 8 is accommodated, move the key 8, insert the key 8 into the keyhole 91 of the lock 9, and cause the key 8 to pivot in the first direction to lock the lock 9. The robot 20 then causes the arm A to pull the key 8 out of the keyhole 91, move the key 8, and return the key 8 to the accommodation section.

In this case, the arm A performs, after extracting the key 8 from the section where the key 8 is accommodated, performs the action of moving the key 8 to the insertion action start position 60 close to the keyhole 91, the insertion action of inserting the key 8 located in the insertion action start position 60 into the keyhole 91, the pivotal action of causing the key 8 to pivot in the first direction, and the pull-out action of pulling the key 8 out of the keyhole 91. The arm A then moves the key 8 and returns the key 8 to the accommodation section. The following description will be primarily made of the action of moving the key 8 to the insertion action start position 60, the insertion action, and the pivotal action, whereas the action of extracting the key from the section where the key 8 is accommodated, the pull-out action, and the action of returning the key 8 to the accommodation section will be briefly described.

In the locking task, the robot control apparatus 30 causes the arm A to extract the key 8 from the section where the key 8 is accommodated, then performs first control, second control, third control, fourth control, fifth control, and sixth control in this order, and then causes the arm A to move the key 8 and return the key 8 to the accommodation section. In the action of moving the key 8 to the insertion action start position 60, the first control is performed, and in the insertion action described above, the second control and the third control are performed. In the pivotal action described above, the fourth control and the fifth control are performed. In the pull-out action described above, the sixth action is performed. In the second control, the third control, the fourth control, the fifth control, and the sixth control, the local coordinate system LC is used.

When the robot 20 performs the locking task, the robot controlling section 45 performs the force control on the arm A in at least part of the locking task. In more detail, the robot controlling section 45 performs the force control on the arm A in at least part of the insertion action, at least part of the pivotal action, and in at least part of the pull-out action.

In the present embodiment, in at least the insertion action, the pivotal action, and the pull-out action, the force control is performed on the arm A. In this case, in the insertion action, the force control and the position control are performed in each of the second control and the third control. A detailed description will be made with reference to FIGS. 5 to 11.

In the locking task, first of all, the arm A grasps the key 8, extracts the key 8 from the section where the key 8 is accommodated, and then performs the first control. In the first control, a first action of performing the position control on the arm A to move the point of interest T on the key 8 to the insertion action start position 60 (step S101 in FIG. 11) is performed, as shown in FIG. 6.

Each process is then carried out, for example, the force detection section 21 is reset and compensation relating to gravity, such as gravity compensation and external force compensation, is set (step S102 in FIG. 11). That is, the control section 36, when resetting the force detection section 21, performs the gravity compensation (compensation relating to gravity), more accurately, sets the gravity compensation (compensation in relation to gravity). The gravity compensation (compensation relating to gravity) may be initiated immediately or may be initiated when the second control, which will be described later, is performed.

To reset the force detection section 21, the end effector E (front end portion of arm A) is caused to take the same posture taken when the point of interest T on the key 8 is located in the keyhole 91, for example, when the key 8 is located in a first position 61. In this stage, resetting the force detection section 21 allows the locking task to be quickly and properly performed.

Resetting the force detection section 21 is a concept including initialization of the force detection section 21 (zero-point correction) and is specifically setting the output value (detection value) from the force detection section 21 at a predetermined value (reference value). In other words, resetting the force detection section 21 is, for example, eliminating or reducing the effect of gravity due to variation in the weight of the key 8 (first target object), the posture of the arm A, and other factors, the effect of drift due to leakage current in a circuit of the force detection section 21, thermal expansion, and other factors, and other effects. That is, resetting the force detection section 21 is setting the value outputted from the force detection section 21 under the effect of gravity due to variation in the weight of the key 8, the posture of the arm A, and other factors, the effect of drift due to leakage current in a circuit of the force detection section 21, thermal expansion, and other factors, and other effects at a predetermined value. The predetermined value is preferably “0”.

Further, compensation relating to gravity, such as the gravity compensation and external force compensation, is performed in the second to sixth control, which will be described later. The gravity compensation is adding or subtracting a value corresponding to a change in the posture of the robot 20 to or from the value outputted from the force detection section 21 in such away that the effect due to gravity is eliminated or reduced.

In the external force compensation, force that eliminates or reduces force that the self-weights of the end effector E and the key 8 exert on the key 8 via the keyhole 91 is added to target force in the force control.

Specifically, the target force in the force control is so set that force having a magnitude that is 9.8 times the total mass of the end effector E and the key 8 or lower acts on the key 8 in a direction that falls within ±10° with respect to the direction of gravity (negative X direction).

The insertion action, the pivotal action, the pull-out action, and other actions can thus be smoothly performed with small force at high speed, whereby the locking task can be quickly and properly performed.

The second control is then performed. In the second control, a second action of performing the force control and the position control on the arm A to insert the point of interest T on the key 8 into the keyhole 91 to a middle position therein, that is, the first position 61, is performed, as shown in FIG. 7. In the present embodiment, the first position 61 is a position in a tapered portion formed from the entrance of the keyhole 91 to an inner predetermined position, specifically, a position of an end portion of the tapered portion on the side opposite the entrance thereof.

In the second action, first target force (1 N, for example) is set as the target force in the Z direction in the force control, and the key 8 is moved in the positive Z direction with the first target force on the condition that the second action is terminated when the force detection section 21 detects first force (step S103 in FIG. 11). Further, in the second action, target force in the X direction and target force in the Y direction in the force control are set at “0” excluding force corresponding to the external force compensation, and a copy action (copy control) is performed in the X and Y directions under the settings described above. The first force is not limited to a specific value and can be set as appropriate in accordance with a variety of conditions.

It is then evaluated whether or not the point of interest T on the key 8 has reached the first position 61 (step S104 in FIG. 11). In a case where a result of the evaluation shows that the point of interest T has not reached the first position 61, the position control is so performed on the arm A that the key 8 is moved in the negative Z direction by a predetermined distance and further moved in at least one of the X and Y directions by a predetermined distance (step S105 in FIG. 11). A retry has thus been prepared. In the present embodiment, out of the X and Y directions, the key 8 is moved in the Y direction. The control then returns to step S103 in FIG. 11, and the step 5103 and the following steps are carried out again.

In a case where a result of the evaluation in step S104 in FIG. 11 shows that the point of interest T has reached the first position 61, the control proceeds to step S106 in FIG. 11.

As described above, in the case where the point of interest T on the key 8 cannot be moved to the first position 61 in the first second action, the second action is repeatedly performed until the point of interest T reaches the first position 61.

As a result, the point of interest T on the key 8 is located in the first position 61, and the insertion action is continuously performed.

As described above, in the second control in the locking task, the robot controlling section 45 causes the arm A to move at least one of the key 8 and the lock 9 in the direction in which the key 8 and the lock 9 approach each other, and in a case where the key 8 has come into contact with a position different from the position of the keyhole 91 on the basis of the output from the force detection section 21, the robot controlling section 45 moves at least one of the key 8 and the lock 9 in the direction in which the key 8 and the lock 9 move away from each other.

Therefore, when the key 8 comes into contact with a position different from the position of the keyhole 91, a situation in which the key 8 or the lock 9 is damaged or deformed can be avoided.

The force control in the second control is force control for causing the arm A to position the key 8, in the present embodiment, the point of interest T in the first position 61. Further, the first target force in the force control does not necessarily have a specific value but is set as appropriate in accordance with a variety of conditions.

The third control is then performed. In the third control, a third action of performing the force control and position control on the arm A to insert the point of interest T of the key 8 into the deepest portion of the keyhole 91, that is, a second position 62, is performed, as shown in FIG. 8.

In the third action, second target force (10 N, for example) is set as the target force in the Z direction in the force control, and the key 8 is moved in the positive Z direction with the second target force on the condition that the third action is terminated when the force detection section 21 detects second force (step S106 in FIG. 11). Further, in the third action, the target force in the X direction and the target force in the Y direction in the force control are set at “0” excluding the force corresponding to the external force compensation, and the copy action is performed in the X and Y directions under the settings described above. The second force does not necessarily have a specific value and can be set as appropriate in accordance with a variety of conditions.

As a result, the point of interest T on the key 8 is located in the second position 62 in the keyhole 91, that is, at the deepest portion of the keyhole 91.

As described above, the force control in the third control is force control for causing the arm A to position the key 8, in the present embodiment, the point of interest T in the second position 62. Further, the second target force in the force control does not necessarily have a specific value but is set as appropriate in accordance with a variety of conditions. In the present embodiment, the first target force and the second target force differ from each other. In the present embodiment, the second target force is greater than the first target force. As a result, the point of interest T can be moved from the first position 61 to the second position 62 at high speed, whereby the locking task can be quickly performed.

Further, the distance in the Z direction between the first position 61 and the second position 62 is greater than the distance in the Z direction between the insertion action start position 60 and the first position 61. The key 8 can therefore be moved at high speed in the segment having a long distance, whereby the locking task can be quickly performed.

In the present embodiment, in the fourth control, which will be described later, the target force in the Z direction in the force control is set to third target force, but not necessarily. Instead, before the point of interest T on the key 8 is located in the second position 62 in the keyhole 91, the target force in the Z direction in the force control may be set at the third target force. In this case, the third target force is preferably smaller than the second target force, whereby a situation in which the key or the lock 9 is broken, damaged, deformed, or otherwise degraded can be avoided.

The present embodiment has been described with reference to the case where the insertion action causes the front end portion of the key 8 to be located in the position of the deepest portion of the keyhole 91, but not necessarily. For example, in a case where the key 8 has a configuration in which a wide portion of a base end portion of the key 8 comes into contact with a portion close to the entrance of the keyhole 91 when the front end portion of the key 8 is located in a position ahead of the position of the deepest portion of the keyhole 91, the position where the wide portion of the base end portion of the key 8 comes into contact with the portion close to the entrance of the keyhole 91 may be set as the second position.

The fourth control is next performed, and the fifth control is then performed.

An overview of the fourth control and the fifth control will first be described. In the fourth control and the fifth control, the control section 36, after the key 8 is inserted into the keyhole 91 of the lock 9, controls the action of the robot 20 in such a way that the key 8 is caused to pivot relative to the lock 9 in the first direction while performing a pressing action of pressing the key 8 against the lock 9 in the direction in which the key 8 is inserted into the keyhole 91 of the lock 9 (positive Z direction). In the pressing action, force control in which target force is set in the insertion direction is performed on the basis of the output from the force detection section 21. As a result, the key 8 is readily and smoothly allowed to pivot. The fourth control and the fifth control will be described below in detail.

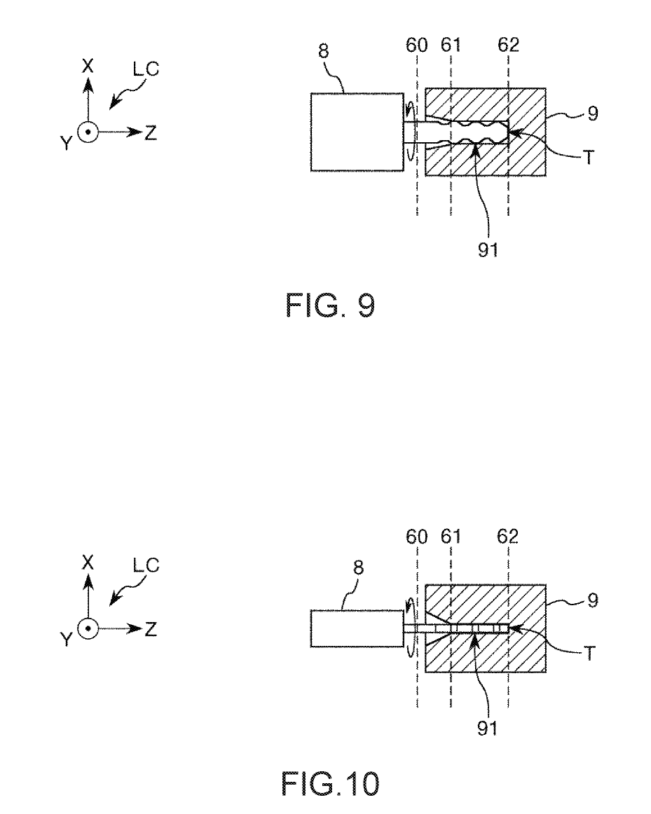

In the fourth control, a fourth action of performing the force control and the position control on the arm A to cause the key 8 to pivot in the first direction by a predetermined angle, in the present embodiment, by 90° is performed, as shown in FIG. 9.

In the fourth action, the third target force (5 N, for example) is set as the target force in the Z direction in the force control, and the key 8 is caused to pivot in the first direction (counterclockwise around Z axis in present embodiment) with the key 8 pressed with the third target force in the positive Z direction on the condition that the fourth action is terminated when the key 8 is caused to pivot in the first direction by 90° and located there (step S107 in FIG. 11).

The control section 36 performs the position control, that is the control section causes the key 8 to pivot relative to the lock 9 in the first direction (90-degree pivotal motion) on the basis of information on the position of the key 8 (information on angle of pivotal motion, for example). The action of causing the key 8 to pivot in the first direction can therefore be properly performed.

The fourth action allows the key 8 to pivot in the first direction by 90°, and the pivotal action is continuously performed. Further, causing the key 8 to pivot in the first direction with the key 8 pressed in the positive Z direction allows the key 8 to pivot readily and smoothly.

The third target force does not necessarily have a specific value and is set as appropriate in accordance with a variety of conditions. In the present embodiment, the second target force and the third target force differ from each other. In the present embodiment, the third target force is smaller than the second target force. As a result, the key 8 is allowed to pivot readily and smoothly.

The fifth control is then performed. In the fifth control, a fifth action of performing the force control and the position control on the arm A to cause the key 8 to pivot in the first direction by a predetermined angle, in the present embodiment, by 90° is performed, as shown in FIG. 10. The fifth action and the fourth action described above cause the key 8 to pivot by 180° in the first direction.

In the fifth action, the key 8 is caused to pivot in the first direction with the key 8 pressed with the third target force in the positive Z direction on the condition that the fifth action is terminated when the key 8 is caused to pivot in the first direction by another 90° and located there (step S108 in FIG. 11). The key 8 has pivoted by 180° in total in the first direction.

The control section 36 performs the position control, that is the control section causes the key 8 to pivot relative to the lock 9 in the first direction (90-degree pivotal motion) on the basis of information on the position of the key 8 (information on angle of pivotal motion, for example). The action of causing the key 8 to pivot in the first direction can therefore be properly performed.

The sixth control is then performed. In the sixth control, a sixth action of performing the force control on the arm A to pull the key 8 out of the keyhole 91 is performed.

In the sixth action, fourth target force is set as the target force in the Z direction in the force control, and the key 8 is moved with the fourth target force in the negative Z direction on the condition that the sixth action is terminated when the key 8 has reached the insertion action start position 60 (step S109 in FIG. 11). The fourth target force does not necessarily have a specific value but is set as appropriate in accordance with a variety of conditions.

As a result, the key 8 is pulled out of the keyhole 91, and the point of interest T on the key 8 is moved to the insertion action start position 60.

The key 8 is then so moved as to return to the section where the key 8 is accommodated. The locking task is thus completed.

The unlocking task is then performed. The unlocking task will not be described in detail and can be performed in the same manner as described above with the first direction described above changed to the second direction.

After the key 8 is pulled out of the keyhole 91 in the locking task, the arm A may wait for a predetermined period with the arm A grasping the key 8 or the arm A may immediately insert the key 8 into the keyhole 91 and unlock the lock 9.

Further, in the present embodiment, the locking task is performed first and the unlocking task is then performed, but not necessarily. The unlocking task may be performed first, and the locking task may then be performed.

Further, after the lock 9 is locked, the key 8 may not be pulled out of the keyhole 91, but the lock 9 may be unlocked, as described above. That is, locking the lock 9 and unlocking the lock 9 may be continuously performed without the action of pulling the key 8 out of the keyhole 91.

In this case, the arm A grasps and moves the key 8, inserts the key 8 into the keyhole 91 of the lock 9 that has not been locked, causes the key 8 to pivot relative to the lock 9 in the first direction to lock the lock 9, temporarily releases the key 8 to achieve the state in which the key 8 is inserted into the keyhole 91, grasps the key 8 again, causes the key 8 to pivot relative to the lock 9 in the second direction to unlock the lock 9, and pulls the key 8 out of the keyhole 91, as described above.

In this task, after the arm A releases the key 8, but before the arm A grasps the key 8 again, the force detection section 21 is reset, and the control of the compensation relating to gravity, such as the gravity compensation and external force compensation, is initiated. The unlocking task can therefore be quickly and properly performed.

Further, in the task described above, the arm A releases the key 8 and grasps the key 8 again, then moves the key 8 in the positive side in the Z direction, causes the key 8 to pivot in the second direction with the key 8 pressed in the positive Z direction to unlock the lock 9. The reason why the key 8 is moved in the positive Z direction after the key 8 is grasped again is that after the key 8 is temporarily released, a spring in the lock 9 moves the key 8 in the negative Z direction in some cases.

Further, in the task described above, after the key 8 is grasped again, but before the key 8 is moved in the positive Z direction, the force control is performed in the X and Y directions, and the target force in the X direction and the target force in the Y direction in the force control are set at “0” excluding the force corresponding to the external force compensation. A copy action is then performed in the X and Y directions.

The other points in the task are the same as those in the locking task and the unlocking task described above.

### Description of Storage and Other Operation of History of Tasks Performed by Robot Control Apparatus

During the tasks, the robot control apparatus 30 stores, in the storage section 32, the insertion positions where the key 8 has been successfully inserted into the keyhole 91 and the number of successful insertion actions with the insertion positions related to the number.

The robot controlling section 45 of the robot control apparatus 30 then controls the arm A on the basis of the insertion positions where the key 8 has been successfully inserted into the keyhole 91 and the number of successful insertion actions. That is, in the tasks, the insertion of the key 8 is aimed at an insertion position where the key 8 has been successfully inserted into the keyhole 91 the greatest number of times. Further, the robot controlling section 45 performs the position control on the arm A when the key 8 is moved to the insertion position where the key 8 has been successfully inserted into the keyhole 91 the greatest number of times. It is therefore expected that the key 8 is successfully inserted in the position to which the key 8 has been moved, whereby the task can be quickly performed.

As described above, the robot system 1 can quickly and properly perform the tasks of locking and unlocking the lock 9.

The robot control apparatus, the robot, and the robot system according to the embodiment of the invention have been described above with reference to the drawings, but the invention is not limited to the embodiment, and the configuration of each portion of the robot control apparatus, the robot, and the robot system can be replaced with a portion having an arbitrary configuration having the same function. Further, an arbitrarily constituent part may be added to the robot control apparatus, the robot, and the robot system.

In the embodiment described above, the first target object is a key, and the second target object is a lock, but not necessarily in the invention. The first and second target objects only need to be so configured that the first target object can be inserted into the second target object and the first target object is allowed to pivot relative to the second target object in the first direction with the first target object inserted into the second target object.

In addition to the above-mentioned combination of the first target object and the second target object, for example, a male connector and a female connector, a plug and a receptacle, a light bulb and a socket, a clutch and a member that attaches the clutch, and other combinations are conceivable.

In the embodiment described above, the robot performs the tasks by grasping the first target object, moving the first target object, and causing the first target object to pivot, but not necessarily. For example, the robot may instead be configured to grasp the second target object, move the second target object, and cause the second target object to pivot.

Further, for example, a double-arm robot may be employed (multi-arm robot including at least three arms may instead be employed) as the robot, and the robot may be configured to perform the tasks by causing one of the arms to grasp the first target object and the other arm to grasp the second target object. In this case, only the first target object may be moved and caused to pivot, only the second target object maybe moved and caused to pivot, or the first and second target objects may be moved and caused to pivot.

That is, the robot only needs to perform the tasks by moving the first and second target objects and causing them to pivot relative to each other.

In the present specification, the term “insertion” is used within a wide concept including fitting (fitting insertion), screw engagement (screw insertion), bonding, linkage, and other attachment forms. Therefore, depending on the configuration of the insertion section, the term “insertion” can be replaced with “bonding,” “linkage,” or any other term.

A program for achieving the function of an arbitrary constituent part in each of the apparatus described above (robot control apparatus 30, for example) may be recorded on a computer readable recording medium, and the program may be read and executed by a computer system. The term “computer system” used herein is assumed to include an OS (operating system) and hardware, such as a peripheral apparatus. The term “computer readable recording medium” refers to a portable medium, such as a flexible disk, a magneto-optical disk, a ROM, and a CD-ROM (compact disc ROM), and a storage device built in the computer system, such as a hard disk drive. Further, the “computer readable recording medium” is assumed to encompass a component that holds a program for a fixed period, such as a volatile memory (RAM) in a computer system that works as a server or a client in a case where the program is transmitted over the Internet or any other network or a telephone circuit or any other communication circuit.

The program described above may be transmitted from the computer system including the storage device or any other component that stores the program to another computer system via a transmission medium or a transmission wave traveling through a transmission medium. The term “transmission medium” used herein, through which the program is transmitted, refers to a medium having the function of transmitting information, such as the Internet and other networks (communication networks) and a telephone circuit and other communication circuits (communication lines).

The program described above may instead be a program that achieves part of the functions described above. The program described above may still instead be a program that achieves the functions described above when combined with a program having already been recorded in the computer system, that is, what is called a difference file (difference program).

The entire disclosure of Japanese Patent Application No. 2016-194386, filed Sep. 30, 2016 is expressly incorporated by reference herein.

What is claimed is:

1. A robot control apparatus comprising:
a processor that is configured to execute computer-executable instruction so as to control a robot including a force detection section,
wherein the processor is configured to reset the force detection section before a first target object is inserted into a second target object and after the first target object has been inserted into the second target object.

2. The robot control apparatus according to claim 1, wherein points of time after the first target object is inserted into the second target object are points of time after the insertion but before the first target object is pulled out of the second target object.

3. The robot control apparatus according to claim 1, wherein points of time after the first target object is inserted into the second target object are points of time after the first target object is pulled out of the second target object but before the first target object is inserted into the second target object again.

4. The robot control apparatus according to claim 1,
wherein the processor is configured to, after performing the insertion, control an action of the robot in such a way that the first target object is caused to pivot relative to the second target object in a first direction while performing a pressing action of pressing the first target object against the second target object in a direction in which the first target object is inserted into the second target object, and
perform force control with target force set in a direction of the insertion based on an output from the force detection section in the pressing action.

5. The robot control apparatus according to claim 4, wherein the processor is configured to perform position control to cause the first target object to pivot relative to the second target object in the first direction.

6. The robot control apparatus according to claim 1, wherein the processor is configured to perform compensation relating to gravity.

7. The robot control apparatus according to claim 1, wherein the first target object is a key and the second target object is a lock.

8. A robot that includes a force detection section and inserts a first target object into a second target object,
wherein the robot is controlled by the robot control apparatus according to claim 1.

9. A robot that includes a force detection section and inserts a first target object into a second target object,
wherein the robot is controlled by the robot control apparatus according to claim 2.

10. A robot that includes a force detection section and inserts a first target object into a second target object,
wherein the robot is controlled by the robot control apparatus according to claim 3.

11. A robot that includes a force detection section and inserts a first target object into a second target object,
wherein the robot is controlled by the robot control apparatus according to claim 4.

12. A robot that includes a force detection section and inserts a first target object into a second target object,
wherein the robot is controlled by the robot control apparatus according to claim 5.

13. A robot that includes a force detection section and inserts a first target object into a second target object,
wherein the robot is controlled by the robot control apparatus according to claim 6.

14. A robot that includes a force detection section and inserts a first target object into a second target object,
wherein the robot is controlled by the robot control apparatus according to claim 7.

15. A robot system comprising:
the robot control apparatus according to claim 1; and
the robot controlled by the robot control apparatus.

16. A robot system comprising:
the robot control apparatus according to claim 2; and
the robot controlled by the robot control apparatus.

17. A robot system comprising:
the robot control apparatus according to claim 3; and
the robot controlled by the robot control apparatus.

18. A robot system comprising:
the robot control apparatus according to claim 4; and
the robot controlled by the robot control apparatus.

19. A robot system comprising:
the robot control apparatus according to claim 5; and
the robot controlled by the robot control apparatus.

20. A robot system comprising:
the robot control apparatus according to claim 6; and
the robot controlled by the robot control apparatus.
